(19) United States
(12) Patent Application Publication
(10) Pub. No.: US 2013/0322958 A1
(43) Pub. Date: Dec. 5, 2013

(54) ATTACHMENT MECHANISM

(71) Applicants: Leor TIKOTZENSKI, Hanasi (IL); Amir LAOR, Kibbutz Dan (IL)

(72) Inventors: Leor TIKOTZENSKI, Hanasi (IL); Amir LAOR, Kibbutz Dan (IL)

(73) Assignee: PLASAN SASA LTD., M.P. Marom Hagalil (IL)

(21) Appl. No.: 12/472,673

(22) Filed: May 27, 2009

(30) Foreign Application Priority Data
May 29, 2008 (IL) 191807

(51) Int. Cl. F16B 21/08

(52) U.S. Cl. CPC F16B 21/08
USPC 403/326

(57) ABSTRACT

An attachment mechanism adapted for attachment of an armor element to a body to be protected by the armor element, the attachment mechanism comprising a first unit and a second unit which are adapted to engage with each other to provide the attachment comprises a second static member and a working member. One of the static members is adapted for fixed attachment to the armor element, and the other is adapted for fixed attachment to the body to be protected. The mechanism further comprises a screw-free locking arrangement between the two static members, defined by a locking gap associated with a locking body portion in the first static member, and a locking tongue portion of the working member in the second unit. The locking tongue portion is displaceable relative to the second static member so as to move into the locking gap to assume a locked position in which at least in one cross-sectional plane of the mechanism, the locking body portion of the first static member separates between the locking tongue portion of the working member and a portion of the second static member.

### FIELD OF THE INVENTION

This invention relates to armor elements, such as, for example, armor panels, and to mechanisms for their mounting on a vehicle to be protected.

### BACKGROUND OF THE INVENTION

Armor panels are commonly used to protect a body against various threats, mostly incoming projectiles. Such armor panels are adapted to dissipate and/or absorb the kinetic energy of the incoming projectile in order to prevent it from penetrating the body.

When it is desired to protect a body, for example, a vehicle, armor panels are usually mounted onto the exterior/interior of the vehicle and are fastened to become affixed thereto.

Mounting of an armor panel onto a vehicle is normally performed either by welding the armor panel onto the hull of the vehicle at a location thereon in which protection is sought or by bolting, where the armor panel and the hull of the vehicle are pre-formed with corresponding bores/threads for receiving therein bolts/screws to attach the armor panel to the hull.

In the former case, the armor panel is affixed to the hull permanently, whilst in the latter case the armor panel is detachably attached to the hull and may serve as an add-on panel.

### SUMMARY OF THE INVENTION

According to one aspect of the present invention there is provided an attachment mechanism adapted for attachment of an armor element to a body to be protected by said armor element, said attachment mechanism comprising a first unit and a second unit which are adapted to engage with each other to provide said attachment, said first unit comprising a first static member and said second unit comprising a second static member and a working member, one of which static members is adapted for fixed attachment to said armor element, and the other is adapted for fixed attachment to said body to be protected, said mechanism further comprising a screw-free locking arrangement between the two static members, defined by a locking gap associated with a locking body portion in said first static member, and a locking tongue portion of said working member in said second unit, said locking tongue portion being displaceable relative to the second static member so as to move into said gap to assume a locked position in which at least in one cross-sectional plane of the mechanism said locking body portion of the first static member separates between said locking tongue portion of the working member and a portion of the second static member, whereby the locking engagement between the first and second static members of the respective first and second units is achieved.

The locking tongue portion may be adapted for moving into the locking gap along a locking tongue portion trajectory that lies in a gap-entering plane different from and, possibly, perpendicular to said cross-sectional plane, without performing any additional movement with respect to said second static member during its entering said gap, the trajectory of which is other than lying in said gap-entering plane. The mechanism may be designed so that the movement of the locking tongue portion along said trajectory may be the only movement performed by the locking tongue portion during its entering the gap.

The locking tongue portion of the working member may constitute its integral part, and the trajectory of the displacement of the working member causing the entry of the locking tongue portion into the locking gap, may also lie in the gap entering plane.

According to another aspect of the present invention, there is provided an armor element with said first static member mounted thereon, and/or a body to be protected with said second unit mounted thereon.

Said first unit and the second unit may be attached to said armor element and said body to be protected, respectively, by bolts, welding etc.

According to another aspect of the present invention there is provided a kit for producing an armored portion of a body to be protected, said kit comprising:

an armor element; and

an attachment mechanism as described above, possibly, with the static member of said first unit being permanently mounted to said armor element.

According to a further aspect of the present invention there is provided an armored vehicle comprising a hull having said second unit attached thereto at its area to be protected.

The locking arrangement between the two static members may be any appropriate arrangement allowing the self-sufficient locking engagement between the two static members, the term ‘self sufficient’ with respect to the engagement meaning herein as allowing bringing the locking tongue into its locked position by moving the working member solely by hand, e.g. without any additional tools or mechanisms.

The following are some examples of such an engagement:

a snap engagement—in which the locking tongue portion is elastically bendable, allowing the locking tongue portion to take on an initial position and a bent position. In this case, in order to bring the locking tongue portion into its locked position, pressure is first applied to the working member by an operator to bring it into the bent position in which the locking tongue portion may be urged into the locking gap, during the entering movement, and thereafter the locking tongue is allowed to assume its initial position within the locking gap to provide the above engagement.

an interlocking engagement—in which the locking tongue portion and the locking gap are of corresponding interlocking shape. In this case, in order to bring the locking tongue portion into its locked position, the working member is either displaced or rotated by an operator until the locking tongue portion and the locking gap are engaged with one another.

a pressure engagement—in which the locking tongue portion is received within the locking gap under pressure, e.g. a wedge mechanism. In this case, in order to bring the locking tongue portion into the locking gap, an operator must apply pressure to the locking tongue portion during the entering movement thereof into the locking gap. In particular, the working member may be formed as a lever in order to allow the operator to apply said pressure.

The working member of the second unit may be formed with a securing portion adapted to engage a corresponding securing portion formed in the first unit, when the locking tongue is in its locked position.

The attachment mechanism may also comprise a securing arrangement adapted to prevent the working member from spontaneous displacement which may cause movement of the locking tongue portion from its locked position into an open position, which may cause disengagement between the armor element and body to be protected.

The attachment mechanism may also comprise an alignment arrangement providing that the first unit and the second unit are properly aligned when the armor element is mounted onto the body to be protected.

According to one example, the working member and the static member of the second unit are pivotally connected to one another such that displacement of the locking tongue into its locked position is provided by pivotal movement of the working member with respect to the static member.

According to another example, the working member may be adapted for linear displacement with respect to the static member to bring the locking tongue portion into its locked position. In particular, the working member may be constantly spring biased into the latter position, thereby being prevented, inter alfa, from spontaneous displacement from the locked position to the open position of the working member. In this case, displacement of the working member may be provided by applying a force against the biasing force of the spring.

According to one particular design, the working member may be provided with a shifting member adapted to allow an operator to apply pressure against the biasing spring. For example, such a shifting member may be a gripping ring, a handle, a lever and the like, attached to or integrally formed with the working member. Alternatively, the shifting member may be a separate member adapted to constantly engage the working member in order to displace its locking tongue portion from one position to another. For example, the shifting member may be in the form of an eccentric lever mounted onto the second static member and adapted to be displaced between a first position in which it biases the working member against the biasing force of the spring, and a second position in which is allows the biasing spring to displace the working member into its locked position.

According to all of the above examples and designs, the securing portion of the working member may be in the form of a latch or a projection, and the securing portion of the static member may be in the form of a securing bar spaced from the body to be protected and extending generally parallel thereto, such that when the locking tongue is in the locked position, the latch or projection are adapted to be received within the space between the body to be protected and the securing bar, thus preventing disengagement of the armor element from the body to be protected.

According to yet another example, the working member may be adapted for revolving within the static member. For example, it may be in the form of a circular plate fitted within a circular sleeve. In this case, the securing portion of the working member may be in the form of a part of a circular channel and the securing portion of the second unit may be in the form of a securing pin projecting generally perpendicular to the body to be protected, and adapted for being received within the circular channel. In particular, the securing pin may be formed with a head portion having a diameter larger than the diameter of the securing pin, and the channel may have a dimension corresponding to the diameter of the pin, wherein, at a particular point along the channel the dimension of the channel has a widened portion which is slightly larger in dimension, in order to receive therein the head portion of the securing pin.

Thus, in assembly, when the armor element is mounted onto a body to be protected, the head portion of the securing pin is first aligned and then received within the widened portion of the working member until it projects from the other side thereof, and thereafter the working member is revolved within the static member such that securing rod slides within the circular channel until the widened portion thereof is no longer aligned with the head portion of the securing pin, thereby preventing disengagement of the first unit from the second unit.

All the above examples may allow at least one of the following:
quick and easy attachment/detachment of the armor element from the body to be protected;
attachment/detachment of the armor element on a site different from the armor and/or vehicle manufacturing site;
quick and easy replacement of the armor element in case of damaged caused thereto;
space-efficient transportation of a plurality of armor elements and/or the body to be protected to a remote location;
efficient weight distribution—allowing the body to be protected to be transported separately from the armor elements thereof;
reducing weight in a specific terrain—for example, when passing through a terrain where the vehicle may sink, the armor elements may be detached to reduce weight (and be left behind); and
between two bases. For example, when driving the vehicle between two bases, each base may have in stock the armor elements and corresponding attachment mechanism, whereby the armor elements may be removed at one base, the vehicle driven to the other base and the armor elements of the other base being mounted on the vehicle.

### BRIEF DESCRIPTION OF THE DRAWINGS

In order to understand the invention and to see how it may be carried out in practice, embodiments will now be described, by way of non-limiting example only, with reference to the accompanying drawings, in which:

FIG. 1A is a schematic isometric view an attachment mechanism according to one embodiment of the present invention;

FIG. 1B is a schematic exploded view of the attachment mechanism shown in FIG. 1A;

FIG. 2A is a schematic isometric view of an attachment mechanism according to another embodiment of the present invention, in an open position thereof;

FIG. 2B is a schematic isometric view of the attachment mechanism shown in FIG. 2A, in a closed position thereof;

FIG. 2C is a schematic exploded view of the mechanism shown in FIG. 2A;

FIG. 2D is a schematic top view of the attachment mechanism shown in FIG. 2B;

FIG. 2E is a schematic enlarged partial longitudinal cross-sectional view taken along the plane GE shown in FIG. 2A, and denoted by line A-A shown in FIG. 2D;

FIG. 2F is a schematic enlarged partial longitudinal cross-sectional view taken along the plane CS shown in FIG. 2A, and denoted by line B-B shown in FIG. 2D;

FIG. 3 is a schematic exploded view of an attachment mechanism according to a further embodiment of the present invention;

FIG. 4A is a schematic isometric view of an attachment mechanism according to still another embodiment of the present invention;

FIG. 4B is a schematic exploded view of the attachment mechanism shown in FIG. 4A;

FIG. 4C is a schematic isometric view of a static member used in the attachment mechanism shown in FIGS. 4A and 4B; and

FIG. 4D is a schematic isometric view of a working member used in the attachment mechanism shown in FIGS. 4A and 4B.

### DETAILED DESCRIPTION OF EMBODIMENTS

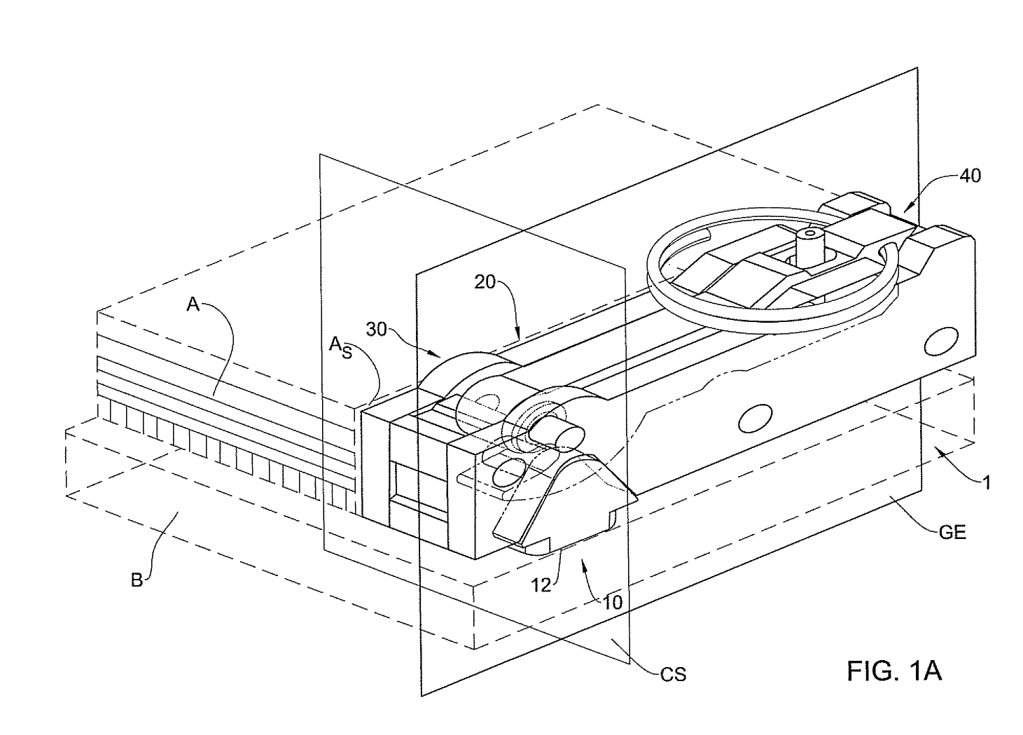

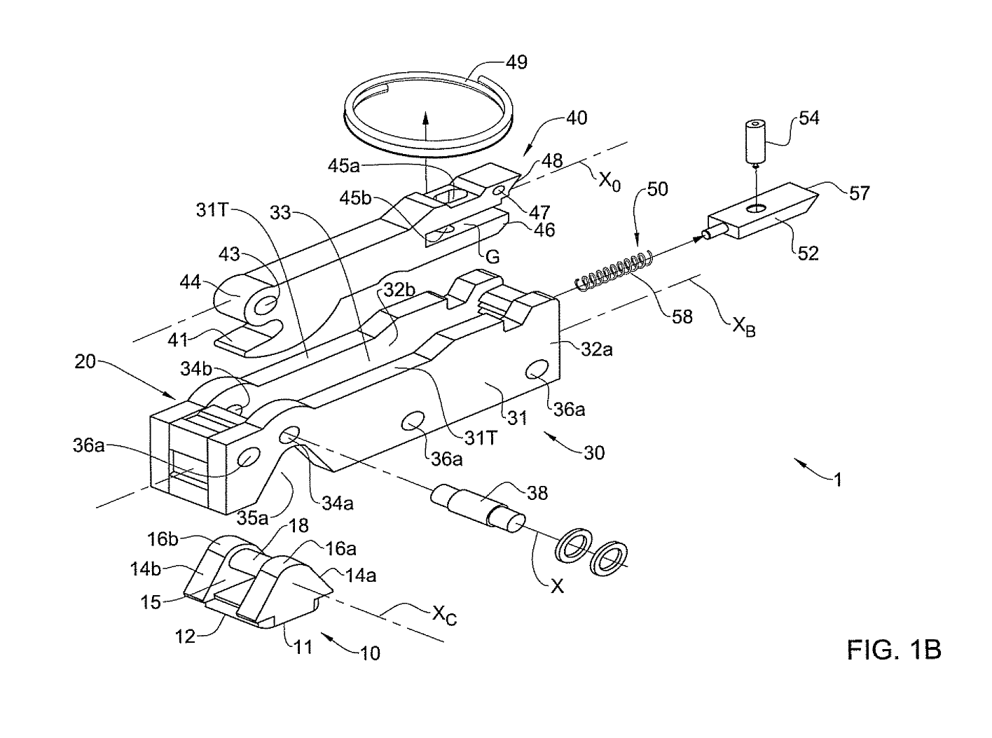

With reference to FIGS. 1A and 1B, an attachment mechanism generally designated as 1, is shown comprising a first unit 20 fixedly mounted on an armor panel A (shown in phantom lines), and a second unit 10 fixedly mounted on a body to be protected B (also shown in phantom lines), which for example, may be a side wall of a hull of a vehicle. The first unit 20 and the second unit 10 are so designed as to be adapted for detachable attachment to one another in a self sufficient manner, i.e. solely by hand, without the use of any instruments or additional attachment elements, such as e.g. bolts or the like.

With reference to FIG. 1B, the second unit 10 has a base portion 12 with a base surface 11, which is rectangular shaped, and is substantially flat, two side walls 14a, 14b extending substantially perpendicular to the base surface 11 and spaced from each other to form and a locking gap 15 therebetween. Each of the side walls 14a, 14b is formed with a convexly curved contact surface 16a, 16b respectively.

The second unit 10 further comprises a locking body portion 18 in the form of a catch extending between the two side walls 14a, 14b along an axis X_{C}. The locking body portion 18 is located such that it binds the locking gap 15 at its end opposite the base portion 12, while leaving a space between the locking body portion 18 and the base portion 12.

The first unit 20 is formed as an assembly comprising a static member 30 adapted for fixed mounting to a flange portion FP of the armor panel A (see FIG. 1A), a working member 40 hingedly articulated to the static member 30 allowing it to assume various positions with respect thereto, and a safety mechanism 50 adapted for securing said working member 40 to the static member 30 at a pre-defined position.

The static member 30 is in the form of an elongated body extending along a longitudinal axis X_{B}, and having two side walls 32a, 32b spaced apart from one another to form a gap 33 therebetween. The side walls 32a and 32b are formed with respective pivot ports 34a and 34b, aligned along an axis X_{P} which is perpendicular to the longitudinal axis X_{B}, for receiving therein a hinge 38, for pivotally articulating thereto the working member 40. In addition, the side walls 32a and 32b are formed with respective aligned attachment holes 36a and 36b, extending perpendicular to the longitudinal direction X_{B}, for attachment of the static member 30 to the flange portion FP of the armor panel A, as shown in FIG. 1A. The static member 30 is further formed with receiving nooks 35a, 35b adapted for engagement with the second unit 10.

The working member 40 is formed of a body 42 extending along a longitudinal axis X_{O} and having a pivot section at one end thereof, and a securing section at another end thereof. The pivot section is formed with a pivot portion 44 having a pivot hole 43, and a locking tongue portion 41 in the form of a latch. The securing portion is formed with a fork-like design, having a first portion 46, and a second portion 48 with a gap G therebetween. The first portion and second portion are formed with respective securing apertures 45a, 45b adapted for engaging a securing mechanism 50.

The securing mechanism 50 comprises a base plate 52 formed with a port adapted to fixedly receive a pulling member 54 projecting perpendicular thereto. The base plate 52 has a first end formed with a spring projection 56 adapted for mounting thereon of a biasing spring 58, and a second end formed with a securing portion 57, adapted to be receive within a securing groove R of the static member 30. The entire securing mechanism 50 is adapted to be received within the working member 40, in particular, the base plate 52 is received within the gap G between the portions 46 and 48, and the pulling member 54 is received within the aperture 45a, thereby preventing the base plate 52 from disengaging from the working member 40. The working member 40 is also fitted with a pulling ring 49 adapted for more convenient application of force against the biasing spring 58.

In assembly, the second unit 10 is welded via surface 11 thereof to the body to be protected B, at a predetermined location, corresponding to the desired future location of the armor element A. The first unit 20 is bolted to the side A_{S} of the armor element A, using bolts passing through the attachment holes 36a and 36b.

When mounting the armor element A onto the body to be protected B, the working member 40 is transverse to the static member 30. The armor element A is then positioned so on the body to be protected B, that the contact surfaces 16a, 16b are received within the respective nooks 35a, 35b, so as to align the armor element A with the body to be protected B.

Once positioned, the working member 40 is pivoted about the pivot point 43 such that the locking tongue portion 41 performs a rotational entering movement the trajectory of which lies in the gap-entering plane GE. Thus, the locking tongue portion is received under the locking body portion 18. The working member 40 is further pivoted until the surface 42 thereof becomes almost flush with the surfaces 31T of the static member 30. It should be noted that during the entering movement, the locking tongue portion does not perform any additional movement the trajectory of which lies outside the gap-entering plane GE.

In the closed position described above, due to the biasing spring 58, the securing portion 57 of the securing mechanism 50 projects outwards to be received within one of the grooves R of the static member 30, preventing further pivoting of the working member 40. In this position, the armor element A is firmly secured to the body to be protected B by virtue of the engagement between the first unit 20 and the second unit 10.

In order to disengage the armor element A from the body to be protected B, it is required to disengage the first unit 20 from the second unit 10. This is performed by pulling on the ring 49, entailing retraction of the base plate 52 using the pin 54, allowing the working member 40 to pivot about the hinge 38 until the locking tongue portion 41 thereof no longer engages the locking body portion 18, whereby the armor element A may be removed from the body to be protected B.

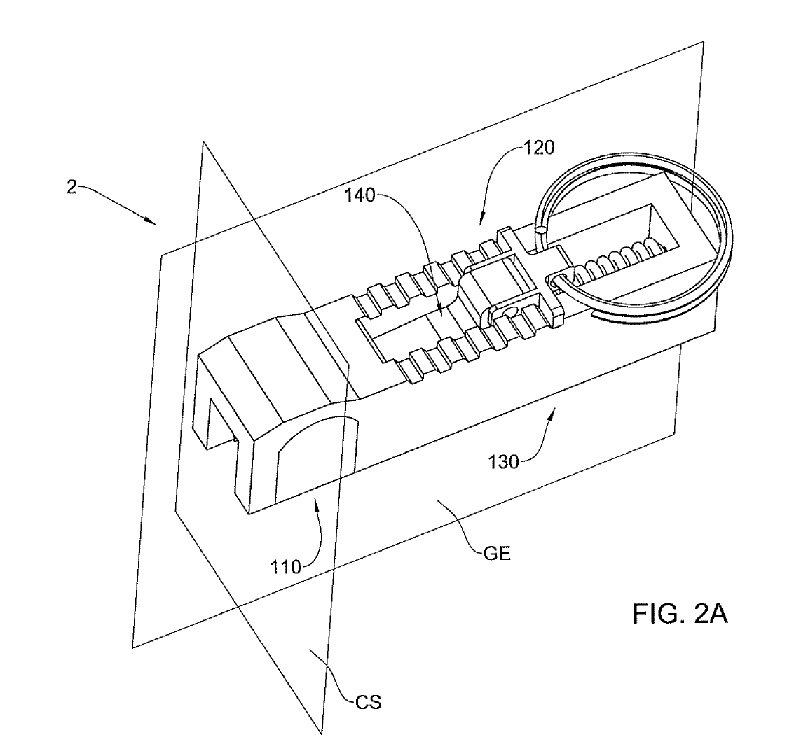

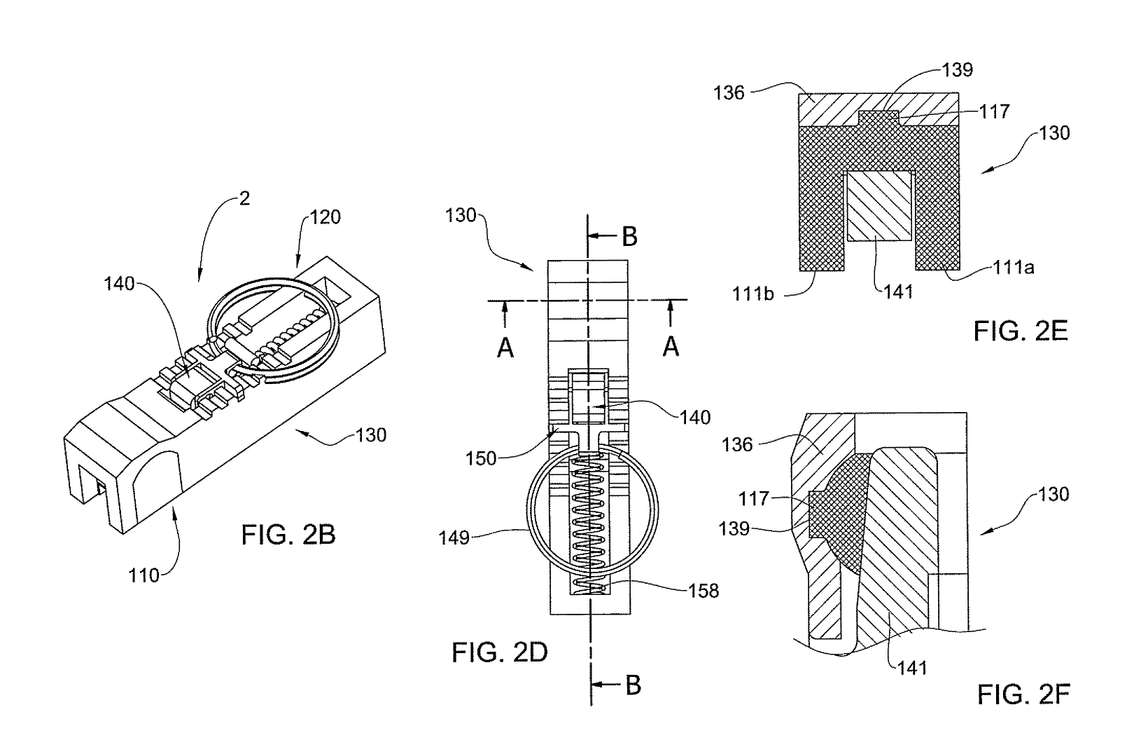

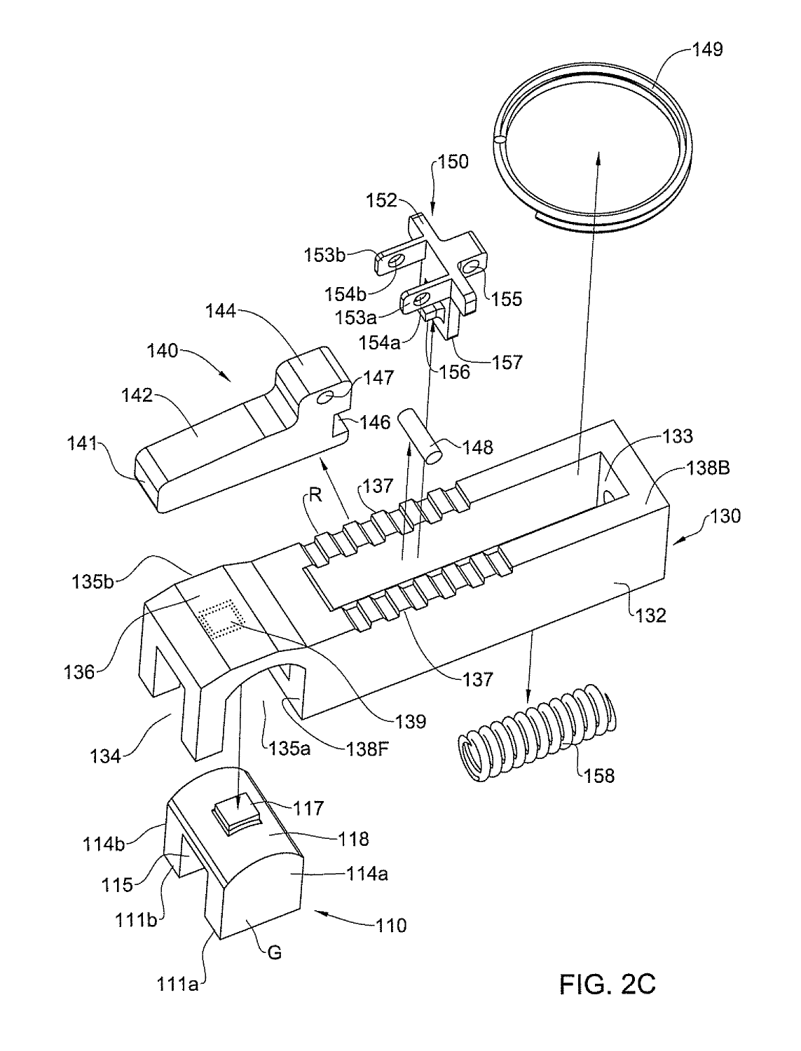

Turning now to FIGS. 2A to 2E, another design of the attachment mechanism is shown generally designate as 2, and comprising a second unit 110 adapted for fixed attachment to a body to be protected B, and a first unit 120 adapted for fixed attachment to an armor element A.

The second unit 110 is formed with two side walls 114a, 114b extending substantially perpendicular to the static portion 112, such that a locking gap 115 extends therebetween. The locking gap 115 is delimited from above by a locking body portion 118. Each of the side walls 114a, 114b is of a generally rectangular shape and is formed with a contact surface 116a, 116b respectively. The locking body portion 118 is formed on a top surface thereof with a rectangular alignment projection 117 adapted for alignment of the second unit 110 with respect to the first unit 120.

The first unit 120 is formed as an assembly comprising a static member 130 adapted for fixed attachment to the armor element, an working member 140 received within the static member 130 allowing it to assume various positions with respect thereof, and a safety mechanism 150 adapted for securing the working member 140 to the static member 130 at a pre-defined position.

The static member 130 is formed with a body 132 extending along a longitudinal axis X_{B}, having a back wall 138B, and a front wall 138F opposite thereto, with two side walls 132a, 132b extending therebetween, being spaced apart from one another to form a gap 133 therbetween. Each side wall 132a, 132b is formed with a nook 135a, 135b adapted for engagement with the second unit 110. Each side wall 132a, 132b is further formed with a securing portion R comprising a plurality of teeth 137 adapted for engagement with the securing mechanism 150.

The static member 130 further comprises a bridge portion 136 adjacent the front wall 138F, the front wall 138F having formed therein an opening 136a. The bridge portion 136 is formed with a rectangular recess 139 adapted, in the assembled position, to receive therein a rectangular projection 117 of the body unit 110.

The working member 140 is formed of a body 142 extending along a longitudinal axis X_{O} and having a locking tongue portion 141 in the form of a wedge at one end thereof, and a securing section 144 at another end thereof. The securing portion 144 is formed with a pivot hole 147, and a recess 146, both being adapted for engagement with the securing mechanism 150.

The securing mechanism 150 comprises a restriction element 152 and a biasing spring 158. The restriction element 152 is formed with a restriction bar 155 adapted for engagement with the teeth 137 of the static member 130, two projections 153a, 153b extending perpendicularly therefrom, and a gripping portion 155 adapted for articulation of a gripping ring 149 thereto. Each of the projections 153a, 153b is formed with an attachment hole 154a, 154b, adapted for articulation to the pivot hole 147 of the working member 140 via a hinge 148.

The arrangement is such that the working member 140 is located within the gap 133 of the static member 130, and the biasing spring 158 is positioned between the back wall 138 and the base element 152, so as to bias the latter, and consequently the working member away from the back wall 138. Thus, in its initial position, the locking tongue portion 141 extends through the opening 136a and under the bridge portion 136.

In assembly, the second unit 110 is welded via surfaces 111a, 111b thereof to the body to be protected B, at a predetermined location, corresponding to the desired future location of the armor element A. The first unit 120 is fixedly attached to the side A_{S} of the armor element A, either using welding, or bolts passing through specifically designed holes (not shown) formed in the side walls 132a, 132b.

When mounting the armor element A onto the body to be protected B, the position of the locking tongue portion 141 prevents the engagement between the second unit 110 and the first unit 120. Thus, the locking tongue portion 141 should first be retracted. However, due to the securing mechanism 150 and the engagement of the bar 152 with the teeth 137, simple lateral movement of the locking tongue portion 141 is prevented. Therefore, it is required to pull on the gripping ring 149 so as to pivot the base element 152 about the working member 140, in order to release the engagement between the teeth 137 and the base element 152. Thereafter, the working member 140 may be displaced towards the back wall 138B against the biasing force of the spring 158 until the locking tongue portion 141 no longer projects from the opening 136.

In this position, it is possible to position the first unit 120 properly, such that the second unit 110 is received within the nooks 135 under the bridge 136, and the projection 117 is received within the rectangular recess 139.

Once positioned, the gripping ring 149 may be released so as to allow the working member 140 to re-deploy, such that the locking tongue portion 141 thereof performs an axial movement along a trajectory lying in the gap-entering plane GE, towards the second unit 110. In this position, the locking tongue portion 141 projects from the opening 136a. However, in this position, the locking tongue portion 141 also extends within the locking gap 115, preventing disengagement between the first unit 120 and the second unit 110.

Particular attention is drawn to FIGS. 2E and 2F, in which a cross-section of the area of the second unit 110 is shown, in which it may be observed that, in this particular example, along both the cross-sectional plane CS and the gap-entering plane GE, the locking body portion 118 is disposed between the locking tongue portion 141 of the working member 140 and a portion of the static member 130.

When disengaging the first unit 120 from the second unit 110, a similar operation is performed to that required for engaging the units 110, 120 one with the other, i.e. the locking tongue portion 141 is retracted, allowing the two units 110, 120 to separate from one another.

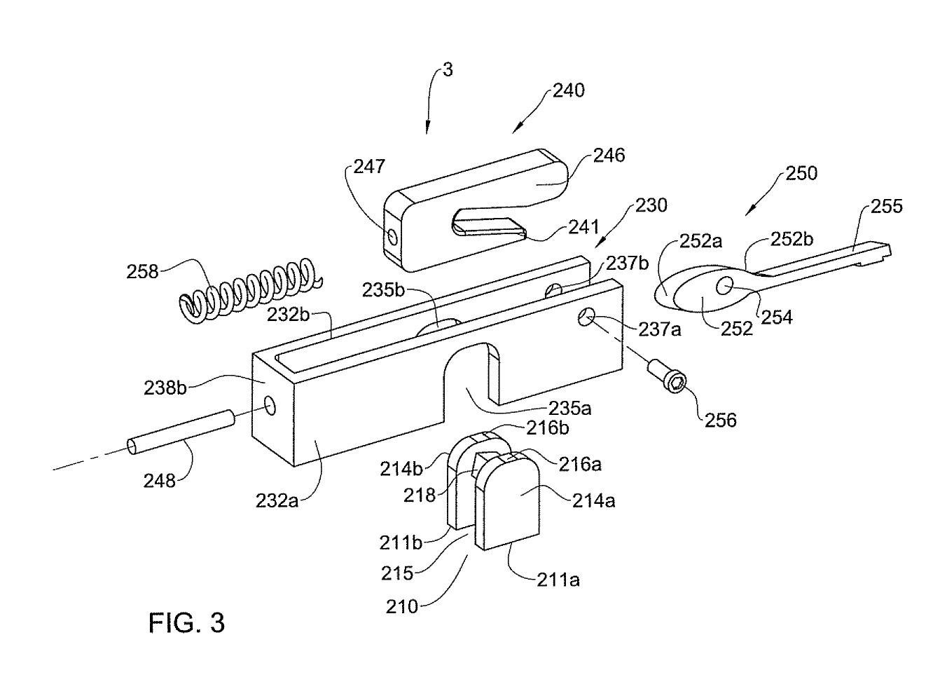

Turning now to FIG. 3, yet another example of an attachment mechanism is shown, generally designated as 3, and comprising a second unit 210 and a first unit 120. The first unit 220 comprises a static member 230, a working member 240 and a securing member 250.

The present example operates in a similar manner to previous example in the sense that the working member 240 is biased by a biasing spring 258 and comprises a locking tongue portion 241 adapted to extend under a locking body portion 218 of the second unit 210 so as to fix it to the static member 230. However, in the present example, the locking mechanism 250 comprises an accentor 252 pivotally articulated to the static member 230 using a hinge 256, and adapted to depress the working member 240 against a force of the biasing spring 258.

In particular, the accentor 252 has an elliptic shape having a first end 252a and a second end 252b, and is formed with a pivot hole 254 located adjacent one of the focal points of the ellipse. In addition, a lever portion 255 extends from the ellipse, adapted for changing the position of the accentor 252.

In assembly, the second unit 210 is welded via surface 211a, 211b thereof to the body to be protected B, at a predetermined location, corresponding to the desired future location of the armor element A. The first unit 220 is attached to the side A_{S} of the armor element A, either by welding, or using bolts passing through the specifically designed attachment holes (not shown).

In mounting, the first unit 220 is brought to a position in which the first end 252a of the accentor 252 engages a pressure portion 246 of the working member 240, and the lever member 255 faces away from the working member 240. Thus, the biasing spring 258 is depressed and the locking tongue portion 241 is retracted, so as to allow the second unit 210 to be received within the nooks 235a, 235b.

Thereafter, the accentor 252 is pivoted about the pivot point 245 thereof, until the pressure portion 246 of the working member 240 engages the second end 252b of the accentor 252. In this position, since the second end 252b is considerably closer to the pivot point 254 than the first end 252a, the working member 240 is free to displace by virtue of the biasing spring 258 away from the back wall 238b, such that the locking tongue portion 241 extends under the locking body portion 218, thereby lockingly engaging the second unit 210.

In disengagement between the first unit 220 and the second unit 210, a reverse operation is performed, i.e. the accentor 252 is pivoted in the opposite direction, thereby pushing the working member 240 backwards, until the locking tongue portion 241 no longer extends under the locking body portion 218, whereby the units 210, 220 are free to disengage.

In general, in the above described embodiment of FIG. 3, the accentor 252 performs the same function as the biasing spring 158 of the attachment mechanism shown in FIGS. 2A to 2F.

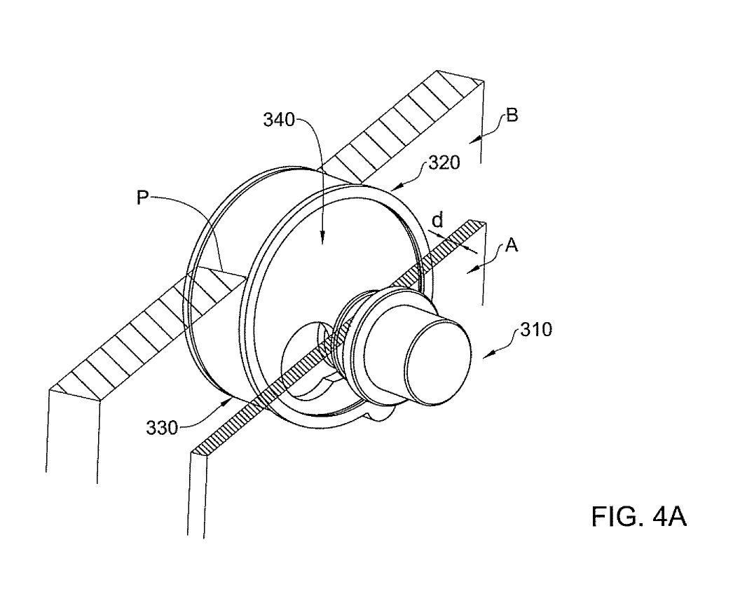

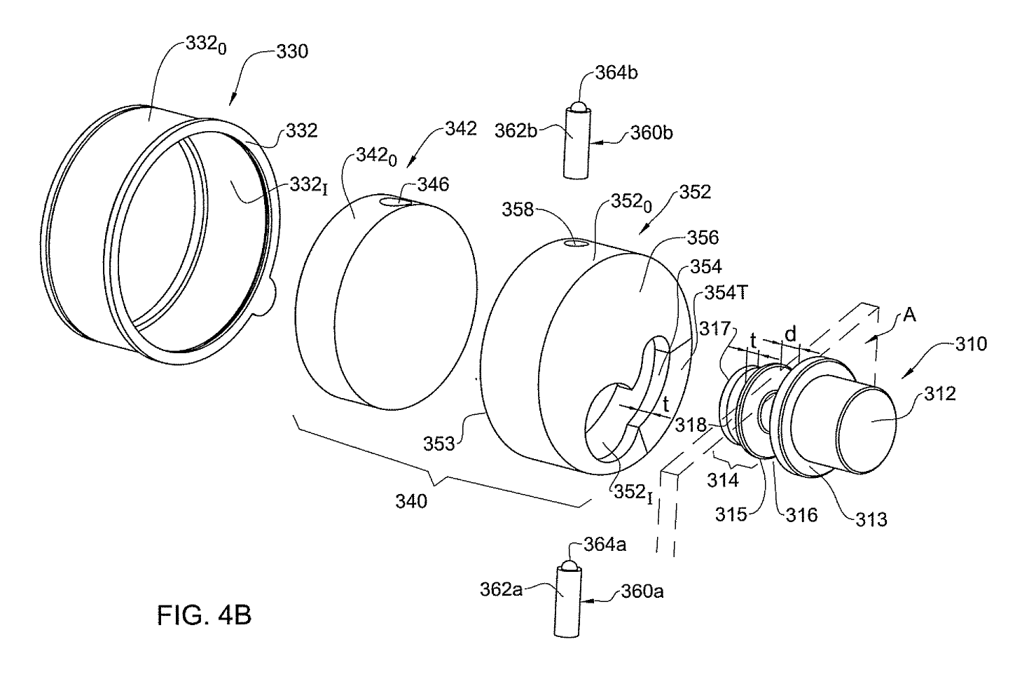

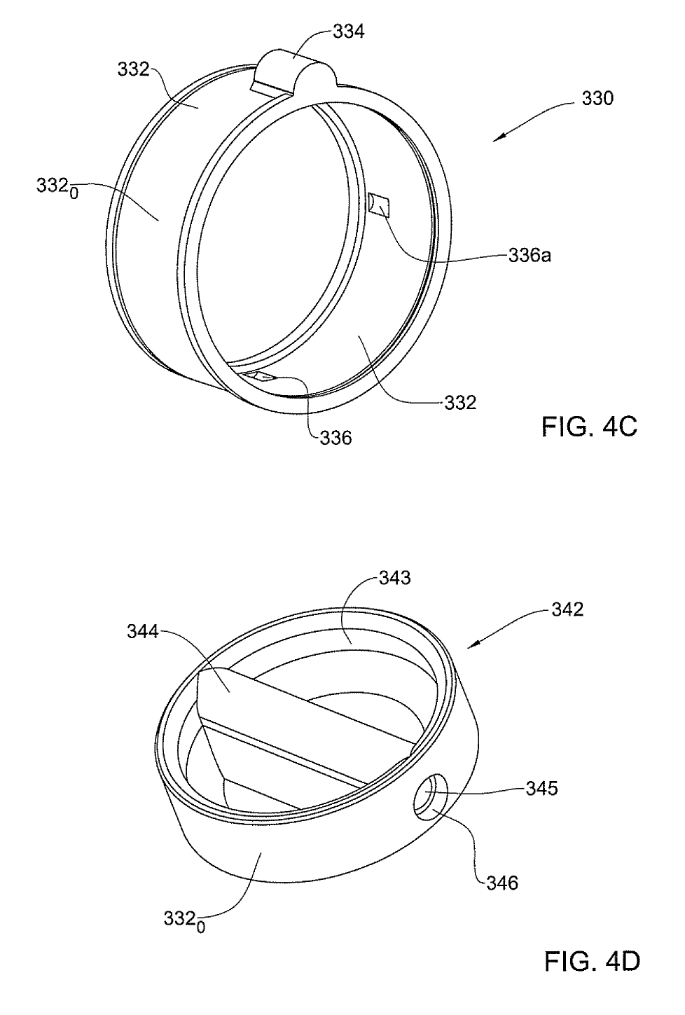

Turning now to FIGS. 4A to 4D, a still further example of an attachment mechanism is shown, generally designated as 4, and comprising a second unit 310 and a first unit 320. The first unit 320 comprises a static member 330 and an operating mechanism 340 comprising an intermediate member 342 and a working member 352. The elements 310, 320, 330 and 340 are all of circular shape, each having a central axis X.

The second unit 310 comprises a first circular member 312 and a second circular member 314 adapted for engagement therebetween along a mutual axis thereof to grasp therebetween the armor element A. Each of the first and second circular member 312, 314 is formed with a respective retention disc 313, 315, the arrangement being such that when the members 312, 314 are engaged, a gap 316 of width d extends between the retention discs 313, 315. The width d corresponds to the width of the armor element A.

In addition, the second circular member 314 is formed with an additional retention disc 317 spaced from the retention disc 315 by a locking body portion rod 318 such that there extends a locking gap of width t therebetween.

The static member 330 is adapted, contrary to the previous examples in which the static member is attached to the armor element from the side, for being embedded within the body to be protected B. In particular, it is embedded such that there is provided access to the first unit 320 both from outside the body to be protected B and from inside the body to be protected B. The static member 330 is in the form of a circular sleeve 332 having an inner surface 332₁ and an outer surface 332_{O}, and is adapted for fixed attachment to the body to be protected, more specifically, for fixed attachment of the outer surface 332_{O} to the inner surface of a prefabricated attachment port P of the body to be protected.

The circular sleeve 332 is further formed on the outer surface 332_{O} thereof with an aligning projection 334, adapted to prevent rotation of the circular sleeve 332 within the attachment port P. In addition, the circular sleeve 332 is formed on the inner surface 332₁ thereof with two recesses adapted for locking the position of the operating mechanism 340 as will be discussed later with respect to the structure of the operating mechanism 340.

The operating mechanism 340 comprises an intermediate member 342 in the form of a circular disc, having an external surface 342_{O}. The intermediate member 342 is formed with a cavity 343 across which extends a gripping portion 344 along the diameter of the cavity 343, allowing an operator to grip the gripping portion 344 from both sides (his fingers being positioned within the cavity 343). The circular disc is further formed with a central channel 345 extending within the gripping portion 344, and adapted for accommodation therein of two securing pins 360a, 360b, one on each side thereof.

The operating mechanism also comprises a working member 352 formed with a cavity 353 adapted for accommodating the intermediate member 342 therein, and having an outer surface 352_{O} and an inner surface 352₁. The working member 352 further comprises a front face 351 perpendicular to the central axis X thereof, the front face 351 being formed with an attachment opening 354 having a first, circle-shaped portion 355 adapted for insertion of the additional retention disc 317 of the second unit 310 therein, and a locking tongue portion 354T in the form of a prolonged narrow portion adapted for sliding of the locking body portion 318 therein. The thickness t of the locking tongue portion 354T corresponds to the width t of the locking gap between the retentions discs 315 and 317.

The working member 352 is also formed with an opening 358 adapted for protrusion of a securing pin 360a therethrough. The securing pins 360a, 360b are each formed with a respective pin portion 362a, 362b, and a respective ball shaped end 364a, 364b, adapted for securing the position of the operating mechanism 340 as will hereinafter be discussed.

The arrangement is such that the intermediate member 342 is fixedly articulated within the working member 352 using one of the securing pins 360b, the outer surface 342_{O} thereof being flush with the inner surface 352₁ of the working member 352. Thus, turning the intermediate member 342 using the gripping portion 344 entails rotation of the working member 352, and indeed of the entire operating mechanism 340 about the central axis X. The second securing pin 360a is adapted to protrude from the opening 346 of the intermediate member 342, and through the opening 358 of the working member 352, such that the ball end 364a thereof is directed towards the inner surface 332₁ of the circular sleeve 332.

The entire operating mechanism 340 is received within the circular sleeve 330 such that the outer surface of the working member 352_{O} is flush against the inner surface 332₁ of the circular sleeve 332. The ball end 364a of the securing pin 360a is received within the one of the recesses 336 of the circular sleeve 332, thereby preventing spontaneous rotation of the operating mechanism 340 with respect to the static member 330.

In assembly, the two members 312 and 314 of the second unit 310 are clamped onto a panel of width d of the body to be protected B from both sides such that the panel is fixedly retained between the two members 312, 314. The first unit 320 is attached to body to be protected, more particularly, the outer surface 332_{O} of the circular sleeve 332 is welded to the inner surface of the attachment port P of the body to be protected.

In mounting, the armor element A along with the second unit 310 is brought such that the retention disc 317 is inserted through the circle-shaped opening 355. Once inserted, the operating mechanism 340 may be rotated about the central axis X using the gripping portion 344, whereby the locking tongue portion 354T slides about the locking body portion 318 of the second unit 310 such that the locking tongue portion 354T of the working member 352 is received within the locking gap of width t between the retention discs 315, 317, effectively trapping the retention disc 317 within the working member 352.

Also in this position, the securing pin 360a is also displaced with respect to the circular sleeve 332, such that the ball end 364a thereof is now received within the other recess 336, preventing spontaneous rotation of the entire operating mechanism 340 to and open position in which that units 310, 320 may be disengaged from one another.

In disengagement between the first unit 320 and the second unit 310, a reverse operation is performed, i.e. the entire operating mechanism 340 is rotated within the static member 330 in the opposite direction, thereby bringing the retention disc 317 to face the circle-shaped portion 355, whereby the units 310, 320 are free to disengage.

Those skilled in the art to which this invention pertains will readily appreciate that numerous changes, variations, and modification can be made without departing from the scope of the invention, mutatis mutandis.

1. An attachment mechanism adapted for attachment of an armor element to a body to be protected by said armor element, said attachment mechanism comprising a first unit and a second unit which are adapted to engage with each other to provide said attachment, said first unit comprising a first static member and said second unit comprising a second static member and a working member, one of which static members is adapted for fixed attachment to said armor element, and the other is adapted for fixed attachment to said body to be protected, said mechanism further comprising a screw-free locking arrangement between the two static members, defined by a locking gap associated with a locking body portion in said first static member, and a locking tongue portion of said working member in said second unit, said locking tongue portion being displaceable relative to the second static member so as to move into said gap to assume a locked position in which at least in one cross-sectional plane of the mechanism said locking body portion of the first static member separates between said locking tongue portion of the working member and a portion of the second static member, whereby the locking engagement between the first and second static members of the respective first and second units is achieved.

2. An attachment mechanism according to claim 1, wherein the locking tongue portion is adapted for moving into the locking gap along a locking tongue portion trajectory that lies in a gap-entering plane different from said cross-sectional plane, without performing any additional movement with respect to said second static member during its entering said gap, the trajectory of which is other than lying in said gap-entering plane.

3. An attachment mechanism according to claim 2, wherein said locking tongue portion of the working member constitutes its integral part, and the trajectory of the displacement of the working member causing the entry of the locking tongue portion into the locking gap, also lies in the gap entering plane.

4. An attachment according to claim 1, wherein there is provided an armor element with said first static member mounted thereon, and/or a body to be protected with said second unit mounted thereon.

5. An attachment mechanism according to claim 4, wherein said first unit and said second unit are attached to said armor element and said body to be protected, respectively, by at least one of the following: bolting and welding.

6. An attachment mechanism according to claim 1, wherein the locking arrangement between the two static members is self-sufficient.

7. An attachment mechanism according to claim 6, wherein said locking arrangement is based on a snap engagement.

8. An attachment mechanism according to claim 6, wherein said locking arrangement is based on an interlocking engagement.

9. An attachment mechanism according to claim 6, wherein said locking arrangement is based on a pressure engagement.

10. An attachment mechanism according to claim 1, wherein the working member of the second unit is formed with a securing portion adapted to engage a corresponding securing portion formed in the first unit, when the locking tongue is in its locked position.

11. An attachment mechanism according to claim 1, wherein said attachment mechanism further comprises a securing arrangement adapted to prevent the working member from spontaneous displacement of the locking tongue portion from its locked position into an open position.

12. An attachment mechanism according to claim 1, wherein said attachment mechanism further comprises an alignment arrangement providing that the first unit and the second unit are properly aligned when the armor element is mounted onto the body to be protected.

13. An attachment mechanism according to claim 1, wherein the working member and the static member of the second unit are pivotally connected to one another such that displacement of the locking tongue into its locked position is provided by pivotal movement of the working member with respect to the static member.

14. An attachment mechanism according to claim 1, wherein the working member is be adapted for linear displacement with respect to the static member to bring the locking tongue portion into its locked position.

15. An attachment mechanism according to claim 14, wherein the working member is constantly urged into the locked position.

16. An attachment mechanism according to claim 1, wherein the working member is adapted for revolving within the static member.

17. An attachment mechanism according to claim 16, wherein the working member is in the form of a circular plate fitted within the static member which is in the form of a circular sleeve.

18. An attachment mechanism according to claim 17, wherein the locking tongue portion of the working member is in the form of a part of a circular channel and the locking portion of the first unit is in the form of a securing pin projecting generally in the direction of rotation of the working member, and adapted for being received within the circular channel.

19. A kit for producing an armored portion of a body to be protected, said kit comprising:
an armor element; and
an attachment mechanism of claim 1.

20. A kit according to claim 6, wherein the static member of said first unit is permanently mounted to said armor element.

21. An armored vehicle comprising a hull having the second unit of the attachment mechanism of claim 1 attached thereto at its area to be protected.
